(19) United States
(12) Patent Application Publication
(10) Pub. No.: US 2021/0296925 A1
(43) Pub. Date: Sep. 23, 2021

(54) BATTERY COMBINER

(71) Applicant: Galvion Ltd., Portsmouth, NH (US)

(72) Inventors: David Long, Northborough, MA (US); James Storer, San Diego, CA (US); Sean Patrick Gillespie, Boston, MA (US)

(73) Assignee: Galvion Ltd., Portsmouth, NH (US)

(21) Appl. No.: 17/202,760

(22) Filed: Mar. 16, 2021

Related U.S. Application Data
(60) Provisional application No. 62/990,640, filed on Mar. 17, 2020.

(51) Int. Cl. H02J 9/06; H02J 7/00

(52) U.S. Cl. CPC H02J 9/061; H02J 7/0031; H02J 7/0047; H02J 7/0013

(57) ABSTRACT

A battery combiner having three power ports for interfacing with a DC power load and with two DC power batteries or other DC power sources. A conductive path interconnects the three power ports. A switching circuit includes a switch for each of the DC power battery ports with each switch operable by a controller to direct current flow between one battery and the DC power load while isolating the other battery from the other conductive path. Sensors corresponding with each power port sense voltage and/or current from each of the external devices. Data ports corresponding with each power port allow communication between the controller and smart external devices connected to the power ports. The battery combiner is operable to power the DC power load with one battery source until the battery source is depleted and to switch to the other battery source to power the load without interruption.

### CROSS REFERENCE TO RELATED U.S. PATENT APPLICATIONS

The present application claims the benefit under 35 U.S.C. § 119(e) to U.S. Provisional Application Ser. No. 62/990,640, filed Mar. 17, 2020, which is incorporated herein by reference in its entirety and for all purposes.

### COPYRIGHT NOTICE

A portion of the disclosure of this patent document may contain material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice shall apply to this document: Copyright © 2020-2021, Galvion Ltd.

### BACKGROUND OF THE DISCLOSURE

### Field of the Disclosure

The exemplary, illustrative, technology herein relates to systems, software, and methods for delivering electrical power from power sources such as batteries to a power load in a controlled manner.

### The Related Art

Conventional battery powered electrical devices are often powered with a single battery. The single battery typically provides power to each electrical device until the battery charge of the single battery is depleted. When the single battery charge is depleted, the electrical devices being powered stop functioning until a new or recharged battery is installed into the electrical devices or is otherwise connected to the electrical devices to deliver the power needed.

To address this problem, individuals often use multiple batteries connected in series or parallel to provide a source of input power to an electrical device. The multiple batteries operate as a unit, or “power bank,” and can allow the electrical device to be powered for a longer period of time than with a single battery. However, each of the batteries in the unit contribute at least some of their charge to the electrical device during use. As a result, each of the batteries discharge until their charge is depleted, the electrical device stops functioning, and all the batteries must typically be replaced.

Thus, there is a need in the art to provide a battery powered solution that provides uninterrupted power to an electrical device without stopping the operation of the electrical device while changing batteries or battery connections.

Conventional electrical devices and the batteries that provide a source of power to the electrical devices each have an operating voltage range. In order to power an electrical device, the operating voltage range of each battery is matched with the operating voltage range of the electrical device. For a low voltage electrical device, in one example, a single dry cell battery with a 1.5 volt power output is acceptable. Dry cell batteries in various sizes e.g., D, C, AA and AAA are commonly used in these applications. However, when these dry cell batteries are fully discharged, the electrical devices stop operating. The D, C, AA and AAA batteries are typically all 1.5 volt batteries, but each has a different charge capacity. In examples, the charge capacity for a AAA battery is about 1100 mAh, while the charge capacity for a D cell battery is about 15.5 Ah.

When batteries are connected in series to provide a source of power to a circuit, the same current flows through each of the components in the circuit. The voltage of the batteries as a unit is the sum of the voltages of the individual batteries. In one example, connecting three 1.5 volt AAA dry cell batteries together in series can provide a 4.5 volt output as a unit. The voltage across the circuit is the sum of the individual voltage drops across each component in the circuit.

When powering series circuits, circuit designers usually select all batteries of the same type and charge capacity. This is to ensure that each battery discharges substantially the same amount of charge at substantially the same rate. In the case of rechargeable batteries, this selection also ensures that each battery will charge to its maximum capacity at approximately the same time. Otherwise, the batteries with the lowest charge capacity will typically deplete sooner than the others, charge sooner than the other batteries upon charging, and can overcharge/overheat while the larger capacity batteries are still charging. This can compromise the charge capacity of all connected batteries.

In the aforementioned example of AAA batteries connected in series, the charge capacity of each battery is about 1100 mAh, and the charge capacity of the batteries as a unit is thus also approximately 1100 mAh. During use, all of the batteries discharge approximately the same current at approximately the same rate, and thus become depleted of charge at approximately the same time.

When batteries are connected in parallel to provide power to a circuit, the charge capacity of the parallel-connected batteries as a unit is the sum of the charge capacities of each battery, but the voltage across each branch of the circuit is the same. Because the voltage is the same across all circuit branches, circuit designers preferably select all batteries to have the same operating voltage range. In one example, connecting three D cell batteries in parallel provides a charge capacity of 46.5 mAh for the parallel-connected batteries as a unit. However, each of the batteries contribute power to the electrical load, eventually become depleted of charge and the electrical load stops operating.

Disadvantages of the conventional battery connection schemes include the inability to provide continuous power while changing batteries and the inability to discharge one battery at a time when multiple batteries are connected in parallel or in series. Additionally, users often replace batteries that still have remaining charge because there is no convenient way to determine a battery state of charge of each battery while each battery is powering an electrical device.

### SUMMARY OF THE DISCLOSURE

A simplified autonomous battery changing device (“battery combiner”) is proposed. The battery combiner includes power ports that can be configured to either receive direct current (DC) power from power sources such as batteries and battery chargers, or to deliver DC power to electrical devices that consume DC power (“power loads”). These power sources and power loads are devices that are external to the battery combiner and electrically interface with its power ports and are thus referred to collectively as external devices.

In one embodiment, the battery combiner includes at least two power ports configured as input ports and at least one power port configured as an output port. Each of the input ports connect to power sources such as batteries, and the output port connects to a power load such as a radio or lamp, in examples.

The battery combiner can select at least one power source from the two or more connected power sources and deliver the power from each selected power source to the power load without interrupting power to the power load. For this purpose, the battery combiner can preferably select one connected power source (e.g., battery) to provide a source of input power to the power load, and “swap” to another connected power source when the battery combiner determines that the currently selected power source has reached a predetermined level of charge depletion.

During and after the swap, the power load continues to be powered without interruption. For this reason, the battery combiner is said to provide uninterruptible power to the power load.

The battery combiner can select each input battery to power the power load based on power characteristics for each battery, including charge capacity, operating voltage range, state of charge and possibly other criteria.

The need in the art is relevant for both “smart” and “non-smart” batteries and power loads, also known as smart and non-smart devices. The smart devices store and maintain power characteristics in non-volatile memory and can communicate this information to a processor for analysis. For this purpose, the smart devices can have wired signaling interfaces or data communications interfaces that connect to a communications network. The non-smart batteries and power loads, or non-smart devices, in contrast, do not maintain power characteristics and typically lack signaling or communications interfaces.

In embodiments, the battery combiner can support either non-smart devices only, smart devices only, or a combination of smart and non-smart devices.

In general, according to one aspect, the disclosure features a battery combiner. The battery combiner includes a conductive path, a device port that electrically interfaces with an external device and connects directly to the conductive path, and at least two battery ports that each electrically interface with a different external device, wherein each of the at least two battery ports are separately switchably connected to or isolated from the conductive path. The battery combiner also includes a switching circuit for connecting or isolating the at least two battery ports to or from the conductive path, and a controller including a processor and a memory that connects or isolates the at least two battery ports to or from the conductive path via the switching circuit and obtains power characteristics from each of the external devices. Preferably, the controller provides uninterruptible power to the device port based upon the power characteristics obtained from the external devices when the device port is interfaced with a power load and each of the at least two battery ports are interfaced with a power source.

In one implementation, the battery combiner includes a sensing circuit including sensors that separately connect to the device port and to each of the at least two battery ports, where the sensors sense voltage and/or current values for each of the external devices and represent the sensed values as sensor signals, and where the controller obtains the power characteristics for each the external devices by requesting their sensor signals over the sensing circuit. In another implementation, the battery combiner includes a communications circuit including data ports that separately interfaced with external DC power devices the through corresponding device port and each of the at least two battery ports, where each of the external devices maintain power characteristics and send the power characteristics over the communications circuit via the data ports, and where the controller obtains the power characteristics for each of the external devices by exchanging the power characteristics with the connected devices over the communications circuit.

Typically, the processor compares the power characteristics obtained from the power load and from the power sources to determine whether the power sources are compatible for providing uninterrupted power to the power load.

In one example, the controller provides uninterruptible power to the device port based upon the power characteristics obtained from the external devices when the device port is interfaced with a power load and each of the at least two battery ports are interfaced with a power source. For this purpose, in one example, the processor selects one of the at least two battery ports as a primary source and connects it to the conductive path, (“connected battery port”), and isolates all others of the at least two battery ports from the conductive path (“isolated battery ports”). The processor then designates one of the isolated battery ports as a secondary source, monitors the power characteristics from the primary and the secondary sources, and compares the power characteristics to a primary swap trigger and a secondary swap trigger that respectively define a threshold level of charge for the primary source and a threshold level of charge for the secondary source. Upon determining that the primary swap trigger is met, the processor connects the battery port for the secondary source to the conductive path and then isolates the battery port for the primary source from the conductive path.

In another implementation, the controller provides uninterruptible power to a first of the at least two battery ports based upon the power characteristics obtained from the external devices when the first of the at least two battery ports is interfaced with a power load, at least a second of the at least two battery ports is interfaced with a power source, and the device port is interfaced with a power source. For this purpose, in one example, the processor selects the device port as a primary source, connects the first of the at least two battery ports to the conductive path (“connected battery port”), isolates all others of the at least two battery ports from the conductive path (“isolated battery ports”) and designates one of the isolated battery ports as a secondary source. Then, the processor monitors the power characteristics from the primary and the secondary source and compares the power characteristics to a primary swap trigger and a secondary swap trigger that respectively define a threshold level of charge for the primary source and a threshold level of charge for the secondary source. Upon determining that the primary swap trigger is met, the processor connects the battery port for the secondary source to the conductive path.

The battery combiner also includes an indicator that presents a context specific indication in response to the primary swap trigger, or the secondary swap trigger being met. In examples, the power source is a battery charger, or a battery and the power load is a depleted rechargeable DC battery or other DC power load.

In one implementation, the battery combiner includes a controller power circuit connected to the conductive path that includes a power regulator and an internal battery. The power regulator is disposed between the internal battery and the conductive path, and the power regulator enables the internal battery to either send power over the conductive path to provide power to the switches, the sensors or the device port and any battery ports connected to the conductive path, or to receive power from the conductive path to charge the internal battery.

The external devices can be either non-smart devices, smart devices, or a mixture of both non-smart and smart devices. Preferably, the device port and the at least two battery ports support bidirectional DC power.

In another example, the external device that is electrically interfaced with one of the at least two battery ports of the battery combiner is a second battery combiner. Here, a device port of the second battery combiner can be electrically interfaced with the one of the at least two battery ports of the battery combiner.

In general, according to another aspect, the disclosure features a method of operation of a battery combiner including a device port and at least two switchable ports. The method includes the steps of configuring the battery combiner by connecting external devices to the device port and to the at least two battery ports, wherein the device port is directly connected to a conductive path and the at least two battery ports are switchably connected to or isolated from the conductive path; a controller of the battery combiner obtaining power characteristics from the external devices via the device port and the at least two battery ports; the controller connecting or isolating the at least two battery ports to or from the conductive path based on the power characteristics obtained from the external devices; and the controller providing uninterruptible power to the device port when the device port is interfaced with a power load and each of the at least two battery ports are interfaced with a power source.

The method also can activate an indicator to alert an individual that the primary source requires replacement.

### BRIEF DESCRIPTION OF THE DRAWINGS

The features of the present disclosure will best be understood from a detailed description of the disclosure and example embodiments thereof selected for the purposes of illustration and shown in the accompanying drawings in which:

FIG. 1 depicts an exemplary schematic diagram of a first battery combiner embodiment, in accordance with principles of the present disclosure, where the battery combiner is configured to operate with non-smart external devices via sensors of a sensing circuit of the battery combiner;

FIG. 2 depicts an exemplary schematic diagram of a second battery combiner embodiment, where the battery combiner is configured to operate with smart external devices via data ports of a communications circuit of the battery combiner;

FIG. 3 depicts an exemplary schematic diagram of a third battery combiner embodiment that can support either smart or non-smart external devices;

FIG. 4 is a flow chart that describes a method of operation of a battery combiner as shown in FIG. 1, where the method is preferably directed to the power management of non-smart batteries as power source external devices for delivering uninterruptible power to one or more non-smart power loads;

FIG. 5 is a flow chart that describes another method of operation of a battery combiner as shown in either FIG. 2 or FIG. 3, where the method is preferably directed to the power management of smart batteries as power source external devices for delivering uninterruptible power to one or more smart power loads;

FIG. 6 shows one example for how multiple battery combiners can be connected or linked together to form a battery combiner bank; and

FIG. 7 is a schematic diagram of a field deployable communications system to which the inventive battery combiner is applicable.

### DESCRIPTION OF SOME EMBODIMENTS

### Overview

A battery combiner is proposed to solve the problem of swapping among multiple battery power sources that provide a source of input power to a power load, without interrupting the input power provided to the power load, and to solve the problem of more fully discharging individual batteries of the multiple battery power sources before swapping among the multiple battery power sources.

These and other aspects and advantages will become apparent when the Description below is read in conjunction with the accompanying Drawings.

### Definitions

The following definitions are used throughout, unless specifically indicated otherwise:

| TERM | DEFINITION |
|---|---|
| Power source | an electrical device or component of an electrical circuit |
| | that provides a source of input power to a power load. |
| | Examples include batteries, battery chargers, solar |
| | power panels, electrical generators and capacitors. |
| Power load | an electrical device or component of an electrical circuit |
| | that consumes electrical power |
| Parallel circuit | A closed circuit in which the current divides into two or |
| | more branches before recombining to complete the |
| | circuit, where each branch receives the same voltage, |
| | and the total circuit current is equal to the sum of the |
| | individual branch currents. |
| Series circuit | A closed circuit in which all of the components carry |
| | the same current and the current flows through only one |
| | path. |
| State of | A measure of the remaining capacity or remaining |
| Charge (SOC) | specific energy of a battery, in ampere-hours, expressed |
| | as a percentage. |
| Electrical | A single electrochemical energy storage cell configured |
| energy | to store electrical energy and to discharge the stored |
| storage cell | electrical energy through power terminals. |
| Battery | One or more electrochemical energy storage cells |
| | configured according to a battery standard, e.g., with a |
| | predefined output voltage, charge capacity, and form |
| | factor. Batteries can be single use or rechargeable. |
| Battery | A battery capacity is typically characterized as having a |
| Capacity | specific energy in ampere-hours (Ah). |
| Depleted | A battery that has a reduced capacity/level of charge but |
| battery | is not fully discharged. A depleted battery can continue |
| | to provide power to operate a power load for a time |
| | period that is dependent upon the power needs of the |
| | power load and the remaining level of charge of the |
| | battery. |

### ITEM NUMBER LIST

The following item numbers are used throughout, unless specifically indicated otherwise.

| # | DESCRIPTION | | |
|---|---|---|---|
| 100 | Battery combiner | 200 | Battery combiner |
| 105 | Power load | | |
| 106 | Indicator | 205 | Power Load |
| 110 | Device port | 210 | 1^{st} Data port |
| 112 | Controller | 212 | controller |
| 115 | External DC power device | 215 | External DC power device |
| 120 | External DC power device | 220 | External DC power device |
| 130 | Power Port | 230 | 3^{rd} Data port |
| 132 | Power cable interface | 240 | Controller power circuit |
| 135 | Conductive path | 255 | Communication circuit |
| 140 | 1^{st} switch | 260 | Network interface |
| 145 | 2^{nd} switch | 265 | Power regulator |
| 150 | processor | 270 | Network interface |
| 155 | Sensing circuit | 285 | Internal power source, |
| | | | such as a battery |
| 160 | Memory | 130A, | Battery port |
| | | 130B | |
| 165 | 1^{st} Sensor | 700 | Communications system |
| 170 | 2^{nd} Sensor | 602 | Battery charger |
| 175 | 3^{rd} Sensor | 110A, | Device port |
| | | 110B | |
| 180 | Switching circuit | 602 | Battery charger |
| 192 | Conductive path | | |
| 292 | Power circuit | 125A, | Battery port |
| | conductive path | 125B | |
| 295 | User interface | 130A, | Battery port |
| | | 130B | |
| 300 | Battery combiner | 700 | Communications system |
| 305 | Temperature sensor | 710 | Power hub |
| 312 | Controller | P1-P6 | Ports (of power hub) |
| 392 | Conductive path | 722 | Communications receiver |
| 600 | Battery combiner bank | 724 | Two-way radio |
| 602 | Battery charger | 726 | smartphone |
| | | 750 | Flexible solar panel |
| | | 740-1 | Rechargeable batteries |
| | | through | |
| | | 740-4 | |

### Exemplary System Architecture

### First Battery Combiner (100) Sensors Only

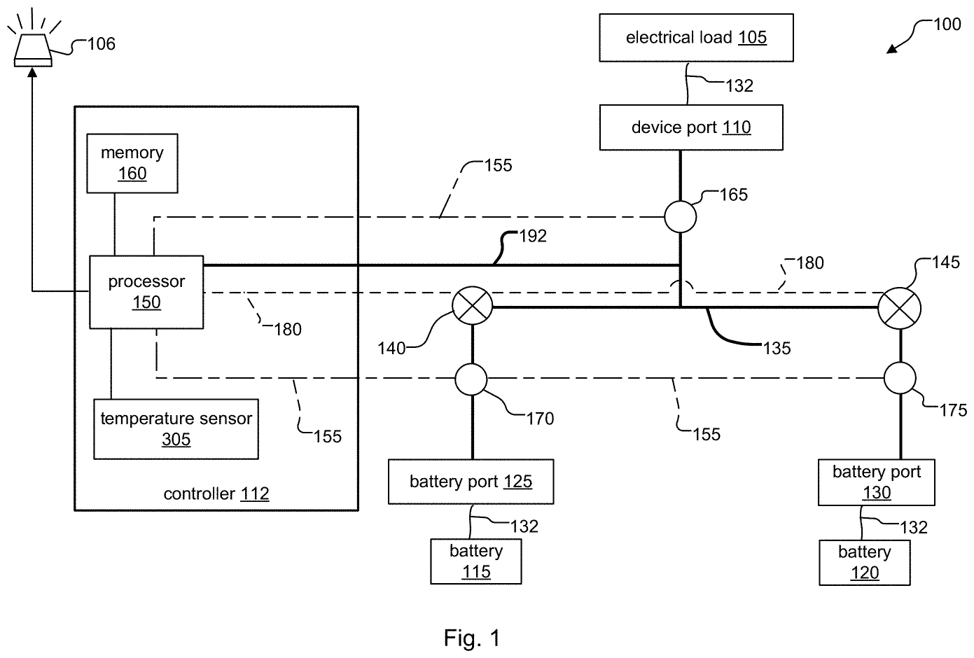

FIG. 1, in a non-limiting exemplary embodiment, shows detail for a battery combiner 100. The battery combiner 100 supports non-smart external devices.

The battery combiner 100 includes a controller 112, a switching circuit 180, a sensing circuit 155, a device port 110 and two battery ports 125 and 130. The three power ports are interconnected by a conductive path 135. Device port 110 is directly connected to the conductive path, e.g. always connected, and is typically electrically interfaced with an external DC power load being powered by the battery combiner. Battery ports 125 and 130 are typically electrically interfaced with power sources and each switchably connect with or are isolated from the conductive path 135 via the switching circuit.

The controller 112 includes a processor 150 and a memory module 160. An indicator 106 also connects to the processor 150. A conductive path 192 connects the processor to the conductive path 135 wherein DC power received from the conductive path 192 is used operate the processor.

The battery combiner 100 can also include a temperature sensor 305. The temperature sensor 305 is electrically interfaced with the processor 150. In the illustrated example, the temperature sensor 312 is an integrated component of the controller 112 but could also be a component that is external to the controller 112. The temperature sensor 305 detects instantaneous temperature and records the temperature over time to the memory 160. Instantaneous temperature is important because battery power characteristics are affected by local temperature. In various operating modes, the power characteristics determined by sensors or received from connected power devices may be weighted or biased according to battery temperature and in some instances may be used to weigh or bias swap trigger values.

The switching circuit 180 includes two switches 140, 146 wherein each switch is electrically interfaced with the processor 150 to receive operating commands and electrical power as needed. A first switch 140 is disposed along the conductive path 135 between the device port 110 and battery port 125. A second switch 146 is disposed along the conductive path 135 between device port 110 and battery port 130. The processor 150 is configured to independently actuate each of the switches 140, 145 in response to various program commands loaded into the memory 160 and executed by the processor 150.

Here, the device port 110 is connected to a power load 105, such as a cellular phone or other device that receives its source of input power via the device port 110. In a similar vein, each of the battery ports 125 and 130 are connected to external DC batteries 115 and 120 respectively, which each operate as power sources.

Because the conductive path 192 of the processor 150 connects directly to the conductive path 135, any source of power placed on the conductive path 135 by the switches 140, 146 also provides power to the processor 150.

The sensing circuit 155 includes three sensors 165, 170, 175 and connects each sensor to the processor 150. A first sensor 165 corresponds with the device port 110, a second sensor 170 corresponds with the battery port 125, and a third sensor 175 corresponds with the battery port 130. In various embodiments each sensor is configured to sense power characteristics at a corresponding port or along the conductive path between the port and one or both of the switches. Also each sensor may be conductivity or inductively interfaced the corresponding port or the conductive path 135.

Each sensor is configured to sense a voltage, a current, and/or a power level at the location of each sensor, and to deliver a corresponding sensor signal for each to the processor 150 over the sensor circuit 155 in response. The processor 150 monitors or periodically samples the sensor signals sent from each of the sensors 165, 170, 175. The device and battery ports 110, 120, 125, the switches 140, 145, and the conductive path 135 support bidirectional DC current flow.

The batteries 115, 120 each connect to the battery ports 125, 130 and the power load 105 connects to the device port 110 via wired interfaces 132. Preferably, the wired interface 132 is the same for all ports 110, 125, and 130 so that the electrical load 105 and the batteries 115, 120 can be interchangeably connected to any one of the ports 110, 125, 130.

Each of the power load(s) 105, and the batteries 115, 120 have power characteristics such as an operating voltage range, an operating current range, peak and average power load requirements for power loads, a SOC, a SOH, a charge capacity, a charging profile or the like for rechargeable batteries, an impedance, or the like.

In the illustrated example, the battery combiner 100 is configured such that its device port 110 is preferably interfaced with an external DC power load 105, and its battery ports 125, 130 preferably connect to DC power sources such as the batteries 115, 120. The power load 105 might be a device without an internal battery or other internal power source, such as a radio or an indicator 106, or possibly the power load may include a rechargeable battery that is at least partially depleted, in examples. The power sources might also be a DC power generator, a solar cell, a fuel cell, or a battery charger configured to recharge a rechargeable DC battery that function as power source, in examples. The user is responsible for understanding the intended configuration and use of the ports 110, 125, 130, and is responsible for understanding that the operating voltage range of the external power load and each of the batteries 115, 120 or other power sources should be compatible.

### Second Battery Combiner (200): Data Ports Only

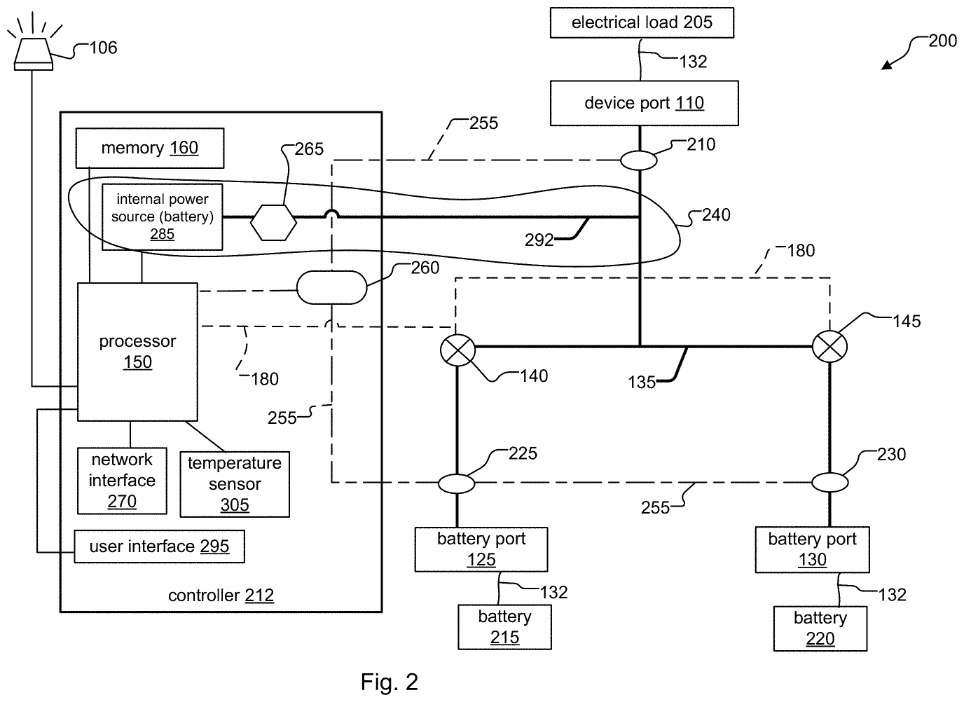

FIG. 2 shows detail for a second battery combiner 200 embodiment. The battery combiner 200 supports smart external devices. In the illustrated example, a power load 205 is electrically interfaced with the device port 110 and smart batteries 215, 220 as power sources are electrically interfaced with the battery ports 125, 130.

The battery combiner 200 includes similar components as the battery combiner 100 of FIG. 1. These components include the power ports 110, 125, 130, the switching circuit 180 and its switches 140, 145, the conductive path 135, the indicator 106, the temperature sensor 305 and the controller (here, the controller is identified by reference 212). However, there are differences.

The battery combiner 200 does not include the conductive path 192 and the sensing circuit 155 and its sensors 165, 170, 175. Instead of the conductive path 192, the battery combiner 200 includes a controller power circuit 240 with conductive path 292. Instead of the sensing circuit 155, the battery combiner 200 includes a communications circuit 255 with data ports 210, 225 and 230. The battery combiner 200 also has changes to its controller 212 to support operation of the communications circuit 255 and the controller power circuit 240.

The controller 212 includes the processor 150, the temperature sensor 305 and the memory 160 as in the controller 112 of FIG. 1 and includes additional components. These components include an internal power source 285 such as a battery, a local area network interface device 260 interfaced with the processor 150 and operating as a network host for each of the data ports 210, 225, 230. A second network interface 270, interfaced with the processor 150, operates as network node configured to connect the battery combiner to a local area network, e.g. that includes other battery combiners, connected power loads, and or, power sources, or the network interface 270 can comprise a cellular or satellite network interface device. The controller 212 also includes a user interface 295 interfaced with the processor 150 or with network interface 270. The user interface 295 is configured to receive input commands from a user and/or to prompt a user to choose an input command or operating mode selection. Any user input is received by the processor 150 and implemented.

The controller power circuit 240 includes the power circuit conductive path 292, an internal power source 285 and a power regulator 265. The power circuit conductive path 292 extends between and connects to the conductive path 135 and the internal power source 285. Optionally, the power regulator 265 includes a regulator switch, not shown, controlled by the processor 150 and/or a passive power regulator. The power regulator 265 is disposed along the power circuit conductive path 292 between the internal power source 285 and the conductive path 135.

The internal power source 285 is preferably a rechargeable battery and the controller 212 is configured to draw power from one or more DC power sources connected to any one of the power ports 110, 115, 120 to recharge the internal power source 285. For this purpose, the processor 150 can open the normally closed internal regulator switch of the power regulator 265 in order to scavenge power from external power sources connected to the battery ports 125, 130 or the device port 110. These power sources can include batteries or a battery charger, in examples.

When the internal power source/battery 285 is charged, the controller 212 is operable as a standalone device. For this purpose, the processor 150 keeps the internal switch of the power regular 256 closed. This allows the controller 212 to operate when there are no external power sources connected to the battery ports 125, 130 or the device port(s) 110 e.g. by powering a communication circuit 225 or the sensor circuit 155, to obtain power characteristics from external DC power devices, or by powering the switching circuit 180, the user interface 295, the network interface 270, or the like, without external power input.

A first data port 210 corresponds with and connects to the device port 110, a second data port 225 corresponds with and connects to the battery port 125, and a third data port 230 corresponds with and connects to the battery port 130. Each of the data ports 210, 225, 230 is in communication with the processor 150 over the communications circuit 255.

The communication circuit 255 may include the single local area network interface device 260 in communication with the processor 150 and with each of the data ports or may include a separate network interface device 260 for each of the data ports 210, 225, 230 that each connect to the processor 150. Alternatively, the network interface device 260 may be incorporated within the processor 150, where the network interface device 260 is implemented as a network protocol translation program, or the like.

In the illustrated example, the power load 205 and the batteries 215, 220 are smart devices. Each stores digital data corresponding with power characteristics for each device in non-volatile memory and may also include a network interface such as may be provided with smart devices, described below. Some of the power loads 205 might also include an internal power source such as a rechargeable battery that is separate from the power load of connected power device itself. In examples, the stored power characteristics information can include an operating voltage range, peak and average power load information of the connected power device and can include power characteristics of the internal rechargeable battery, e.g. a current state of charge (SOC) and a charge capacity and a battery charging profile.

The network interface device 260 manages communication traffic between the processor 150 and the connected devices, e.g. though the data ports. In some operating modes, communication traffic may be exchanged from one smart battery 215, 220 to another over the communication circuit 255 via the processor 150, or from the smart electrical load 205 to one or more of the smart batteries 215, 220 over the communication circuit 255 via the processor 150, e.g. when messages are broadcasted to a selected network node address.

Thus, in one example, the controller 212 can be operated as a network node and can receive user commands or prompt a user to choose an input command or operating mode selection. In another example, because the controller 212 has its own backup or internal power source 285, the controller 212 can continue to power the indicator 106 even after the batteries 215, 220 have become fully discharged.

### Third Battery Combiner (300): Sensors and Data Ports

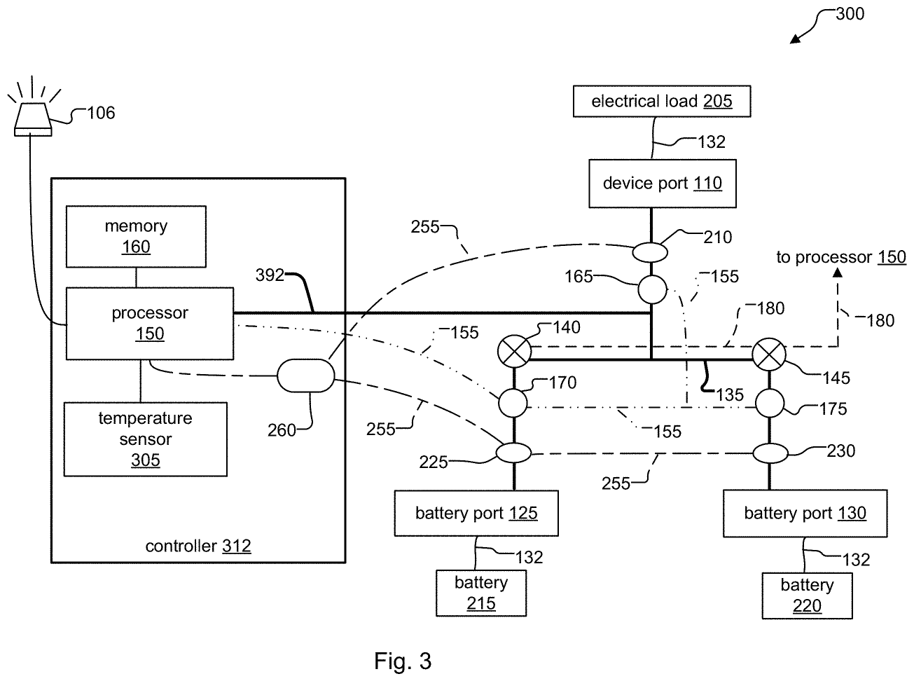

FIG. 3 shows detail for a third battery combiner embodiment 300. The battery combiner 300 includes various components of both battery combiners 100, 200 described herein above. This enables the battery combiner 300 to support either smart or non-smart devices.

The battery combiner 300 includes the same components as the battery combiner 100 of FIG. 1. These components include the three power ports 110, 125, 130, the switching circuit 180 and its two switches 140, 145, the conductive path 135, the sensing circuit 155 and its sensors 165, 170, 175, the indicator 106, the temperature sensor 305 and the controller (here, the controller is indicated by reference 312). The sensors 165, 170, and 175 similarly and respectively interface with connected external power devices over the power ports 110, 125 and 130.

In addition, the battery combiner 300 includes some components of the battery combiner 200 in FIG. 2. In more detail, the battery combiner 300 further includes the communications circuit 255 and its three data ports 210, 255, 230. The data ports 210, 255, and 230 similarly and respectively interface with connected external power devices over the power ports 110, 125 and 130. The controller 312 includes the processor 150, the memory 160, the network interface device 260 and the temperature sensor 305.

The processor 150 controls operation of the switching circuit 180 in substantially the same manner as that of the battery combiners 100, 200. In a similar vein, the processor 150 controls operation of the sensing circuit 155 and the communications circuit 255 as in the battery combiners 100, 200. This allows the battery combiner 300 to operate with either smart or non-smart external devices.

A heated battery, such as a battery at a temperature of about 80° F. or 27° C. usually provides extended discharge time or capacity. However, prolonged exposure to elevated temperatures usually shortens the useful life of the battery. Thus, recording a log listing of instantaneous temperature for a battery is useful because the battery temperature history can be used to predict when a battery will fail.

One measure of battery life is its number of charge and discharge cycles. According to an aspect of the present disclosure, each of the battery combiners 100, 200, 300 is configured to record the number of charge and discharge cycles and the battery temperature history for a selected battery port 215, 220, or for a selected device port 110. In one example, the battery combiners can record this information locally by storing it to the memory 160. For the battery combiners 200, 300 that support communications with wireless networks, the battery combiners can record this information by sending it over the wireless network for storage in a database or other repository that stores information for multiple battery combiners.

The temperature sensor 305 is positioned proximate to the battery being measured, especially when the battery temperature is different from the local ambient temperature, such as when the battery being measured is inside a housing or proximate to equipment that emits thermal energy during operation. In an embodiment, a single temperature sensor 305 is included in the controller 112, 212, 312 or proximate to one or more sensors 165, 170, 175 or the like.

In order to place the temperature sensor 305 proximate to a battery to measure its temperature, the temperature sensor 305 may be incorporated into the end of the wire or cable 132 that connects/electrically interfaces each power port 125, 130 to a corresponding battery 215, 220. In this embodiment, the wire or cable 132 also includes a temperature sensor signal channel that extends from the temperature sensor 305 to the corresponding power port. The temperature sensor 305 may provide a digital temperature signal or an analog temperature signal output, or both. In either case, the battery combiner 100, 200, 300 is configured to deliver a temperature signal to the processor 150 either over the sensing circuit 155 when the temperature sensor 305 is analog, or to deliver the temperature in digital form (e.g., in a communications packet) over the communications circuit 255 via one of the data ports 210, 215, 230.

The processor 150 periodically samples the temperature sensor 305 for instantaneous temperature values. The processor 150 may modify energy management schema that the processor uses to control operation of the battery controller 100, 200, 300 in response to instantaneous temperature values. In examples, based upon real-time temperature readings from the temperature sensor 305, the processor might modify its energy management schema to adjust a minimum operating voltage threshold value used to swap batteries, or to generate a user interface message indicating that a battery has reached its charge/discharge cycle limit. More detail for the energy management schema is provided in the description for the Energy Management Schema section included herein below.

### Optional Elements

Referring to FIG. 1-3, the electronic controller 112, 212, 312 of any of the three battery combiners 100, 200, 300 may optionally include the internal power source/battery 285 shown in FIG. 2. The internal battery 285 is a dedicated power source for powering the battery combiner and for delivering power to whatever elements of the battery combiner require power input. The internal battery 285 can be a non-rechargeable disposable DC battery, a rechargeable DC battery, a photovoltaic cell or the like.

The voltage and power output of the internal battery 285 are preferably matched with the power demands of the electronic controller 112, 212, 312. These demands include powering the processor 150, the memory 160, the indicator 106 and other components or modules that may be added.

The internal battery 285 has advantages. One advantage is that the battery combiners 100, 200, 300 can be powered without requiring an external power device to be connected to one of the power ports 110, 125, 130. Another advantage is that the internal battery 285 can power the indicator 106 to attract the attention of a user, even when only one of at least two batteries connected to the battery combiner become fully discharged. Yet another advantage is that the user interface 295 of battery combiner 200 and the communications circuit (and its optional network interface device 260) of the battery combiners 200, 300 are still powered when there is no power source connected to the power ports 110, 125, 130. Preferably, when power is available from external devices such as batteries, the internal battery 285 is not used for powering the battery combiner.

In a non-limiting example, the internal battery 285 is a rechargeable DC battery that receives charging power from the conductive path 135 and the power circuit conductive path 292 via the power regulator 265. The power circuit conductive path 292 operates to draw power from one or more external DC power sources connected to anyone of the power ports 110, 115, 120 and to route the power via the power regulator 265 to whatever components of the battery combiner that require power in order to power the battery combiner. Preferably, the power regulator 265 conditions the input power to meet the power input requirements of the internal battery 285 and other devices being powered.

In another non-limiting example, the power regulator 265 operates to recognize or sense when a battery charger is connected to the device port 110. In this case, the power regulator 265 operates to divert charging power from the battery charger over the conductive path 135 and the power circuit conductive path 292 to charge the internal battery 285.

Referring to FIGS. 1-3, the electronic controller 112, 212, 312 of any of the three battery combiner embodiments 100, 200, 30 may optionally include the user interface 295 shown in FIG. 2. The user interface 295 is interfaced with the processor 150 and receives power from the processor 150, from the power regulator 265 or from the optional internal battery 285. The user interface 295 may include one or more user input devices, e.g., push-buttons, switches, a keypad, a touch screen, or the like. Preferably, the user interface 295 provides option choices to a user and allows the user to select between the one or more option choices, such as operating modes.

The user interface 295 allows the user to enter configuration information for the battery combiner and/or power sources and power loads that connect to its power ports, and to control operation of the battery combiner. This information can include a device type and an operating voltage range for each external device. The user can also select options on the user interface 295 to control the battery combiner, such as to manually reset the indicator 106 or to request status details for each power source or electrical load 105/205 attached to the power ports. These status details can include a SOC, discharge time remaining, an operating voltage range, or the like. The status details and the configuration information can either be presented for display on a screen of the user interface 295 or can be sent as a report over local area network to a network-connected laptop or mobile user device such as a smartphone carried by the user, in examples.

Referring to FIGS. 1-3, the electronic controller 112, 212, 312 of any of the three battery combiner embodiments 100, 200, 300 may optionally include a network interface device 260, shown in FIG. 2. The network interface device 260 is in communication with the processor 150. The network interface device 260 may comprise a wired Local Area Network LAN interface device, e.g., an Ethernet interface device, or a wireless WLAN network interface device e.g., a WiFi or a Bluetooth network interface device. Alternatively, the network interface device 260 may include a mobile network interface device, e.g., a cellular or satellite network interface device. In all cases, the network interface device 260 is operable to connect with a corresponding network access point and to communicate with other battery combiners or other network devices reachable over the networks to which the corresponding network access point provides access.

### Energy Management Schema

Referring to FIGS. 1-3, the controllers 112, 212, 312 of any of the three battery combiner embodiments 100, 200, 300 are configured to run application programs. The applications programs are stored on the memory 160. In one implementation, a microkernel executed by the processor 150 can select and load the application programs for execution by the processor 150.

The application programs can direct the processor 150 and other components of the battery combiners 100, 200, 300 to perform tasks. The tasks include sampling sensor values, exchanging data over the data ports 210, 225, 230 and sampling temperatures of battery power sources and power loads obtained by and sent from one or more temperature sensor(s) 305. The tasks can also include the ability to alter the configuration of the battery combiner and its components, such as by actuating one or both switches 140, 145 and monitoring the various sensors and data ports for changes in state or status of the external devices connected to the power ports 110, 125, 130. The changes can occur when a user adds or removes an external power source, or when a change in power availability occurs, such as when a minimum operating voltage threshold value is detected, or a threshold charge capacity of a battery is detected. The tasks can also include actuating or resetting the indicator 106.

The application programs are collectively referred to herein as an energy management schema. The energy management schema operates to determine a configuration of the battery combiner, e.g. by determining whether there are external power source devices connected to the power ports, determining a state of each switch 140, 145, interpreting sensor signals, interpreting digital information concerning power sources and power loads received from the data ports, and by interpreting user interface input when the user interface 295 is provided. The energy management schema further operates to analyze a present configuration and the available instantaneous sensor, temperature, and digital information and to determine whether to keep the present battery combiner configuration or to modify the battery combiner configuration according to one or more predetermined rules or policies.

The energy management schema can also direct the processor 150 to reconfigure or otherwise change the run-time behavior of each battery combiner. In examples, the energy management schema can toggle the switches 140, 145 to allow the battery combiner to deliver power to an electrical load 105, 205, 305; operate the power regulator 265 to scavenge power from connected battery power sources and provide the scavenged power to the battery combiner; and direct operation of the switches to “swap” from a critically discharged battery to a fully charged battery.

Still other changes to the battery combiners are possible, either via the energy management schema, the user interface 295, or in response to changes to the power sources and power loads connected to the power ports. The energy management schema can reset the indicator 106. The configuration of the battery combiner can change in response to a user connecting one or more external power source devices to the power ports, in response to user input to the user interface, and in response to communications that include battery characteristics received over the network interface 270 or communications circuit 255. The energy management schema can also modify the configuration of the battery combiner to comply with a safety rule or to protect a connected external power source device from damage. Preferably, the energy management schema reevaluates available information every 100-500 msec.

### Non-Smart Devices

Non-smart devices include power loads 105 such as electronic devices, and power sources such as batteries 115, 120 that consume or store electrical energy but do not include a communication interface, memory, or processor to store digital data that can be accessed over a data port 210, 225, 230. The battery combiners 100, 300 are configured to operate with non-smart connected devices via the sensor circuit 155 and its sensors 165, 170, 175.

While smart batteries 215, 220 and/or smart power loads 205 can be connected to the power ports of the battery combiner 100, there is no opportunity for communication between the smart connected devices and the processor 150 via the power ports. However, when an optional network interface 270, shown in FIG. 2, is incorporated into the battery combiner 100, a smart device may be able to communicate with the processor 150 over a LAN or WLAN network via the network interface 270.

The battery combiners 100 and 300 are configured to connect with non-smart devices over each wire/cable 132, and to receive input power from and deliver output power to the non-smart devices. The power characteristics of the non-smart devices are determined using sensor signals obtained by and sent from the sensors 165, 170, 175 of the sensing circuit 155. Likewise, a configuration of the battery combiners 100, 300 can also be determined based on the sensor signals from the sensors, and the configuration of the battery combiners 100, 300 can be changed in order to receive power from or to deliver power to non-smart devices using sensor signals alone.

Examples of non-smart batteries include single cell electrochemical energy storage devices, such as dry cell batteries. These dry cell batteries are of different types, including AAA, AA, C and D. These batteries may be single use or rechargeable batteries.

Most single cell non-smart commercial batteries use the same battery chemistry and are made to conform with standards for nominal voltage range, battery charge capacity and form factor. Many commercially available, single cell non-smart batteries have an operating voltage range of 1.5 volts DC when fully charged, to about 0.9-1.0 Volts DC when fully discharged.

The non-smart power loads 105 can have various power requirements. Some require a constant source of input power or current flow to operate, such.as a clock, a lamp, or a sensor, while others have variable power load requirements. One example of a power load with a variable power requirement is a two-way radio, which uses more power to transmit a broadcast signal than to listen to or receive a broadcast signal. Other examples include power tools and small household appliances. Any of these power loads 105 can be powered by all three of the battery combiners 100, 200, 300.

### Smart Devices

A smart device includes one or more of the following: a communication interface, a memory, a processor, or other device capable of storing machine readable information related to each device. A smart cable is also usable to store digital information related to a non-smart device when information about a non-smart device is stored on a smart cable, and the data stored on the smart cable can be accessed by the battery combiners 200, 300 through the data ports.

Smart devices may include application programs including a Battery Management System (BMS) or a Load Management System (LMS) module or application program. These application programs typically execute on a processor of the smart devices. The BMS and LMS programs may interface with a physical sensor or other means configured to measure voltage and/or current as well as temperature and may track characteristics such as battery state of charge (SOC), battery State of Health (SOH), battery type, or the like.

Some BMS and LMS programs are configured to self-manage exchanges of power and information between smart devices, using a suitable communications protocol. The self-management may include communication and power exchanges between smart devices connected to the battery combiners 200, 300. The BMS and LMS programs may execute on all smart devices, or possibly only on one of the devices.

The BMS and LMS typically provide a program based interface between each smart device and the energy management schema operating on the processor 150. The program based interfaces operate to negotiate power exchanges, such as by allocating available power to an electrical load connected to the battery combiner 200, 300 when input power is available from connected batteries, or by recharging the connected batteries when a battery charging device is connected to the device port 110. Once a power allocation has been determined, the battery combiner connects corresponding power devices selected for the power exchange by toggling the switches 140, 145 to provide the desired connection.

To interface with smart devices connected to power ports 110, 125, 130, corresponding data ports 210, 225, 230 include a communication channel. This communications channel interfaces with a communication channel of a smart device when the smart device is electrically interfaced to a power port 110, 125, 130 via a wire cable 132. The communication circuit 255 of the battery combiner 200, 300 connects smart devices with the processor 150 to interconnect the energy management schema with corresponding BMS and LMS program based interfaces.

For some smart devices, the data channel and the power channel share a common ground terminal. In a preferred embodiment, the data ports and the power ports are combined into a single power port interface, where the power port includes both the power channel and the data channel in a single electrical connector interface. Additionally, as described herein above, the electrical connector interface may include a temperature sensor 305 and a temperature signal path to the processor 150.

The processor 150 of the battery combiners 100, 200, 300 is configured to request and receive digital data from smart devices. The processor 150 receives the digital data from the smart devices over the data ports 210, 225, 230 shown in FIGS. 2 and 3. In one example, battery combiner 200 is primarily configured to operate with smart devices because the battery combiner 200 lacks sensors 165, 170, 175 associated with each of the power ports 110, 125, 130. As will be recognized, without the sensors, the battery combiner 200 is unable to monitor the power ports for power characteristics such as voltage changes or current flow when non-smart devices are electrically interfaced with the power ports 110, 125, 130.

However, smart devices that include voltage and or current sensors may provide periodic instantaneous voltage and or current values. These values are usable by the energy management schema to make decisions about power exchanges, such as when to reconfigure the battery combiner to swap batteries. The battery combiner 300, in one example, includes both the sensors 165, 170, 175 and the data ports 210, 225. 230 which allow the battery combiner 300 to operate with both smart and non-smart devices. Alternatively, the battery combiner 100 operates with both smart and non-smart connected devices by using sensor information without a digital data exchange.

Example smart batteries and smart battery systems such as military battery systems are preferably used with battery combiners 200 and 300. Existing military batteries such as BB-2590, ELI-2590, and ELI-1614 are available with either a nominal voltage of 14.8V and a charge capacity of 7.5 Ah at 3 A, or a nominal voltage of 29.6V and a capacity of 15 Ah at 6 A, depending on the battery type.

As an example, for the nominal voltage of 29.6V, a military battery has an operating voltage range of between 20.0V and 33.6V, where the voltage is 33.6V when the battery is fully charged and 20.0V when the battery is fully discharged. As noted above, battery power characteristics are temperature dependent, so the above listed voltage values can vary as the temperature changes. Moreover, the reported voltage range is a typical range that can vary from one battery to another. Additionally, the voltage range of rechargeable batteries varies over each battery lifetime depending on the total number of charging and discharging cycles.

Smart power loads can include smart phones, computers, medical devices, power tools, scientific instruments, navigation, communication, weapons systems, and many other portable devices that interface with smart power delivery devices, e.g., Universal Serial Bus (USB) power hubs or the like.

Other smart power loads include user wearable equipment, such as equipment worn by law enforcement, military and medical personnel that carry or wear portable electronic devices. The user wearable equipment often requires uninterrupted power. Yet other examples of user wearable equipment include communication devices, health monitoring devices, cameras, GPS navigation transducers, smart batteries, or the like.

The battery combiners 100, 200, 300 are operable with a smart battery charger connected with one of the power ports, preferably the device port 110. The smart battery charger is operable to discover and recharge one or the other of the batteries connected to the battery ports 125, 130. The batteries can be charged one at a time or simultaneously. The interface between the smart battery charger and the external power devices passes through the processor 150 and the energy management schema may detect the connected battery charger and apply battery charging polices to battery recharging activity.

Typical serial-based network protocols used for communicating with smart connected devices such as user wearable devices include System Management Bus (SMBus), Power Management Bus (PMBus), RS-232, EIA-485, and TIA-485 and its variants. Other network communications protocols can also be supported without deviating from the present disclosure.

Alternatively, communication between the processor 150 and smart devices can be established over the network interface 270, shown in FIG. 2, the smart connected devices are appropriately configured. The network interface 270 may include a wired local area network interface, LAN device or a Wireless Local Area Network WLAN operable to communicate with appropriately equipped smart connected devices and with appropriately equipped other battery combiner devices. Local network protocols may include Wi-Fi, Bluetooth, or various Peer to Peer P2P communication protocols.

Once connected to a power port of the battery combiners 200, 300, a smart battery charger and the processor 150 establish a communication session. The energy management schema recognizes that the smart battery charger is available to charge batteries. Thereafter, the smart battery charger may establish a communication session with a battery to be charged, e.g., over the communication circuit 255 or via the processor 150. After receiving the power characteristics of one or more smart batteries, the smart battery charger configures itself to deliver charging power to the conductive path 135, e.g., from the device port 110, and the battery combiner 200, 300 configures itself to charge a battery connected to one or both of the battery ports 125, 130. In one example, a smart battery charger commercially available from Galvion Ltd. is commercially available under the trade name Adaptive Battery Charger™.

In typical data exchanges, smart devices that interface with the battery combiners 200, 300 over the data ports 210, 225, 23 can exchange power characteristics over the communication circuit 255. The power characteristics may include a battery type, an operating voltage range, a battery SOC, a battery charging profile, device temperature, instantaneous voltage, or current values available from the smart device, or the like. Additionally, information provided by the processor 150 to smart devices may include a configuration of the battery combiner, port addresses for connected power devices, device temperature information, SOC values of other devices, or the like.

### Determined Battery State of Charge (SOC)

A battery operating voltage range can be defined as the difference between an open circuit voltage measured when the battery is fully charged, and the open circuit voltage measured when the battery is fully discharged. Typically, even a fully discharged battery still has a measurable voltage, so a fully discharged battery connected to either one of the battery ports 125, 130 or the device port 110 of the battery combiners 100, 300 can be detected when the sensor signal of a corresponding sensor 165, 170 175 is non-zero. Otherwise, for battery combiner 200, which does not include sensors, the SOC of any connected batteries is provided by the connected batteries or, an instantaneous voltage may be obtained and provided by a BMS or LMS operating on the smart device.

Battery capacity is typically characterized as having a specific energy in ampere-hours (Ah). Specific energy is a measure of discharge current over time when the discharge current is substantially constant. Referring to military battery BB-2590 described above, which has a nominal voltage of 29.6V, the battery capacity is rated at 15 Ah at 6 A. Its voltage range is between 20.0V and 33.6V, where 33.6 V is the fully charged voltage and 20.0V is the fully discharged voltage.

Battery SOC is a measure of the remaining capacity or remaining specific energy of a battery, expressed in milliampere-hours (mAh) or as a percentage. For a battery capacity of 15 Ah at 6 A, in one example, the battery ideally has 100% SOC when fully charged. The same battery has a 50% SOC after operating for 7.5 hours with a constant discharge current of 6 A. Additionally, when the voltage range is known, e.g., between 20.0V and 33.6V, the SOC can be estimated by measuring the instantaneous battery voltage, such as by one of the sensors 165, 170, 175. In the example, when the measured battery voltage is 26.80V, which is the mid-point between the fully charged voltage 33.6V and the fully discharged voltage 20.0V, the SOC is expected to be about 50%. However, this assumes that there is a linear relationship between present voltage and SOC, and instantaneous voltage and SOC may not have a linear relationship. Additionally, the battery capacity is dependent on the battery temperature and on a State of Health (SOH) of the battery.

In a non-limiting example, the SOH of a battery is a ratio of an initial fully charged battery capacity rating, e.g., as manufactured, to a present fully charged battery capacity, expressed as a percentage. The SOH can vary depending on the battery type and the battery application.

SOH deterioration over time is normal. Contributing factors to SOH deterioration include higher than expected battery operating temperature, self-discharge losses, impedance, operating voltage, or the like. Typically, the useful life of a rechargeable battery ends when the SOH is less than 50%, or when a fully charge capacity is about 7.5 Ah at 6A for the prior example. However, in some critical applications batteries are replaced when the SOH is less than 80 or 90%.

### Data Management

The memory 160 is in communication with or incorporated within the processor 150. The memory 160 stores various application programs for operating and configuring the battery combiners 100, 200, 300. The memory further includes one or more data stores, e.g., a local library or a relational database configured to store prepopulated power characteristics of various smart and non-smart external power devices at different temperatures, different battery SOH and at different current discharge rates, or the like.

The processor 150 is also configurable to add relevant data to the local library of the memory 160. The added data may include a specific battery ID, measured voltage, current, and temperature values corresponding with each external device or power port. The added data may also include device connection history, battery discharge durations, total power input for each connected battery, last known SOC, or other charge cycle information such as the total number of charge discharge cycles of connected batteries, or the like.

Additionally, data added to the local library can also be uploaded to a central data facility. In this way, the central data facility can store data from a plurality of other battery combiner devices, sent over time. For this purpose, the battery combiners can connect to a local area network (LAN) or WAN (Wide Area Network) provided by the network interface device 260 of FIG. 2. As a result, computer systems such as laptops, workstations, and smartphones carried by the users can receive notification messages from the battery combiner.

Additionally, via a computer device connected to the same wireless network to which the network interface device 260 also connects, the user can obtain run-time status information of the battery combiner and change data stored in its memory 160. In examples, the user can define primary and secondary swap triggers and change information in a lookup table of the memory 160. More detail for this information is described hereinbelow.

### Lookup Table

According to an aspect of the present disclosure, the processor 150 and the memory 160 are configured to include a lookup table. The lookup table is configured to provide data for various power devices. In one example, the lookup table may list voltage values vs SOC for a plurality of different battery types when the battery types are operating at different battery temperatures. The data may be provided by a battery manufacturer or may be collected during a calibration process, e.g., carried out by a user or by the battery combiner manufacturer.

During calibration of each battery, voltage values are measured and logged in the lookup table while the battery is discharging at a known temperature and a known output current value. The measuring and logging steps can be repeated at a plurality of different battery temperatures for a plurality of different battery types and battery SOH values. Ideally, the measuring and logging is performed when a battery being evaluated or calibrated is being discharged at its rated constant current output, which for the military battery BB-2590, described above, is 6 A over 15 hours, in one example.

In a non-limiting exemplary embodiment, the lookup table is prepopulated with data corresponding with different battery types operating at different temperatures. For this purpose, the data may include SOC vs voltage values at a given temperature for a plurality of different temperatures, battery types, and battery SOH values. Other information stored in the lookup table can include a minimum operating voltage or current threshold value for each different battery type, at a plurality of different operating temperatures.

The minimum operating voltage threshold value is a voltage value that may be used as a swap trigger voltage, which when detected by a sensor during a normal operating mode will trigger the energy management schema to initiate a battery swap.

Other swap trigger events are possible. In one event, when the external devices are smart devices connected to battery combiners 200, 300, the processor 150 receives a message over the communications circuit 255 from the primary source. The message indicates that the SOC of the primary source is below a threshold level, or that its voltage is below the voltage threshold for that battery, in examples. In another event, a smart power load 105 can send a message to the processor 150 indicating that a battery swap should be initiated. In this example, older batteries that have a SOH values that are less than 90% or less than 80% can be included in a data set stored on the lookup table in order for the energy management schema to more accurately trigger battery swaps.

In an operating mode example, some external power devices are identified by device type. In an example, a non-smart battery connected to a battery port 125, 130 has a voltage of 1.4 VDC as determined by a sensor 170 or 175. Without more information, the energy management schema uses the lookup table to identify the battery type using only the 1.4 VDC. In this case, the lookup table may characterize the battery as a dry cell non-smart battery having an operating voltage range of 1.5 volts DC when fully charged to about 0.9-1.0 Volts DC when fully discharged. Additionally, the lookup table may include a SoC value corresponding with the selected battery type having a present voltage of 1.4 VDC. Based on that information, the energy management schema can determine whether the connected battery meets present compatibility requirements of the battery combiner.

### Operating Mode Example Using Sensors

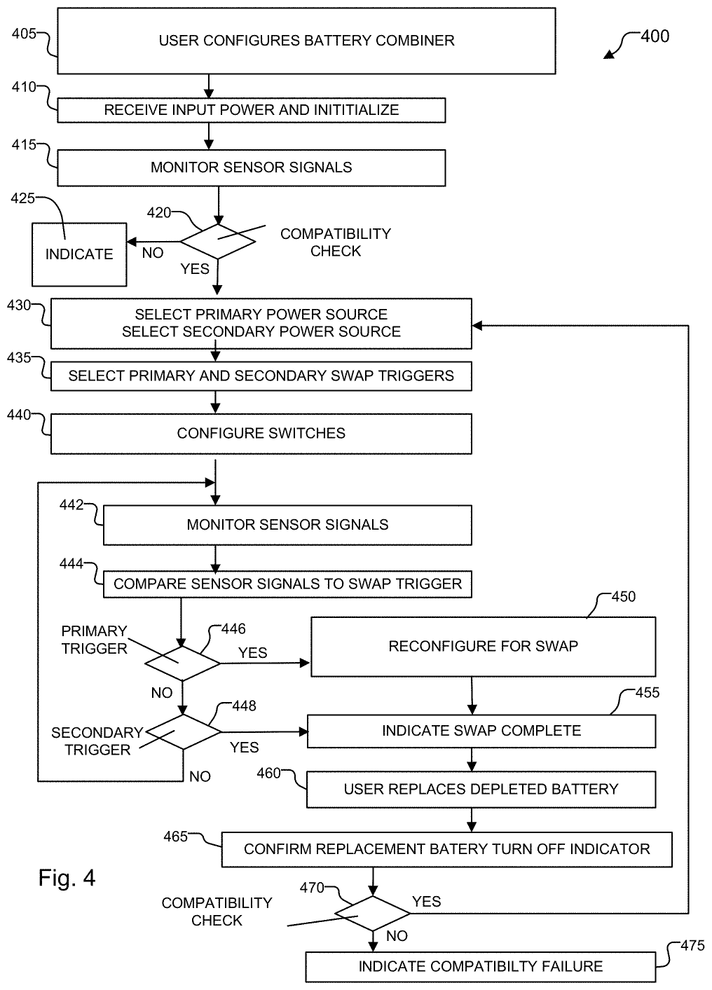

A first, non-limiting, exemplary method of operation 400 of the battery combiners 100, 300 is shown in FIG. 4. In the method, battery combiner 100 obtains power characteristics from non-smart devices using sensors 165, 170, 175 of the sensor circuit 155.

In an initial state, the battery combiner 100, 300 is not powered. The indicator 106 is off and the switches 140 and 145 are both closed to allow current from power sources electrically interfaced to battery ports 125, 130 to flow over the conductive path 135. As a result, current can flow between the battery ports 125 and 130 and the device port 110. Current can also flow from any one of the power ports 110, 115, 120 to the processor 150 and to other components of the controller 112, 312 over any of the conductive paths 192, 292, 392 that extend between the conductive path 135 and the processor 150. Current can also flow to other components of the battery combiner that require input power. The method begins in step 405.

In step 405, the battery combiner 100, 300 is configured based on the external devices the user adds to the power ports. In the illustrated example, the user connects an external power source (here, a battery) to each battery port 125, 130 and connects a power load 105 to the device port 110.

In another example, the user configures the battery combiner 100, 300 by connecting an external power device to each of the three power ports 110, 125, 130, wherein the external power devices include at least one power source and at least one power load. In yet another example, a battery charger is connected to the device port (110), and a rechargeable battery is connected to each of the battery ports 125, 130. In this example, the batteries require recharging and are designated, by the processor, as power loads. In still another example, the user connects a battery charger to the device port 110, a second battery combiner to one of the battery ports, and possibly a rechargeable battery that requires charging to the other battery port.

In step 410, input power is received from an external power source device such as a battery or a battery charger, or another battery combiner attached to a power port and reaches the elements of the battery combiner that require power over the conductive path 135/192/292/392. The power reaches the processor 150 and the battery combiner initializes. Upon initialization, the processor 150 runs a start-up routine. The startup routine may include loading default programs and the applications programs that form the energy management schema from the memory 160 for execution by the processor 150. According to step 415, the processor 150 monitors and samples sensor signals sensed by and sent from the sensor 165, 170, 175 for each external device. The sensor signals are sampled by the processor 150 to determine power characteristics such as a voltage and/or current for each connected device.

Then, in step 420, the energy management schema performs a compatibility check. In more detail, the energy management schema evaluates power characteristics such as the sensor voltage and/or current values for each connected device to determine if the connected devices are compatible for interconnection; e.g., for powering an external power load 105. In one example, the external devices are compatible when all have a substantially similar or overlapping operational voltage range. In another example, the external devices interfaced with battery ports 125, 130 are compatible if they all have a SOC that is sufficient for powering the electrical load 105. If compatible (YES), the method continues to step 430. If NO, the method continues to step 425.

In step 425, the processor 150 activates the indicator 106 and stops further operations. Optionally, the processor can also open both switches 140, 145 to prevent current flow to or from the battery port(s) and preferably only opens one switch if only one connected device is not compatible. The indicator 106 is activated to alert a user that the present combination of external devices is not compatible. For this purpose, the indicator might present a non-compatibility signal, e.g., a flashing light or a different color light, that is recognizable by the user as a non-compatibility signal. Additionally, the processor 150 might send an alert message for display on the user interface 295 if a display interface is provided. Also, if the battery combiner includes an internal network interface device 260, 270 that enables communication with a wireless access point/wireless network, the battery combiner might send a notification message over the wireless network that includes the current state of the battery combiner, its connected devices, and the failure to pass the compatibility check in step 425.

In step 430, the energy management schema selects a primary power source (“primary source”) and designates a secondary power source (“secondary sources”). In the illustrated example, the primary source is selected for powering a power load 105 connected to the device port 110. For this purpose, the energy management schema first determines that power sources are electrically interfaced to both battery ports 125, 130. The primary source is then selected from one of the two battery ports 125, 130. In examples, the power sources may both be dry cells or rechargeable batteries, a battery charger, or other DC power source, or possibly combinations of each. The power source connected to the other battery port is designated as the secondary source.

Various selection criteria or policies are usable by the energy management schema to select the primary source. In one example, when the power sources are batteries, the battery with the lowest SOC is selected as the primary source. In other examples, the battery with the smallest battery capacity is selected, a non-smart battery is selected, or the like.

In another example, an external DC power source, can be selected as the primary source when a user connects a compatible DC power source to the device port 110. In this example, the processor 150 determines that a compatible DC power source is interfaced with the device port 110, a rechargeable DC battery is interfaced with each of the first battery port, and the second battery port. In this situation, the energy management schema selects the compatible DC power source as the primary source and the battery combiner is used to recharge each of the rechargeable DC batteries connected to the battery ports either one at a time or simultaneously. 2.

In a battery combiner operating mode, wherein a power load is connected to the device port 110 and a battery or other power sources is connected to each of the battery ports 125, 130 and a primary power source and a secondary power source has been selected, according to step 435, the energy management schema selects a primary swap trigger and a secondary swap trigger. In more detail, the primary swap trigger is a low voltage and/or current threshold value for the primary power source, while the secondary swap trigger is a low voltage and/or current threshold value for the secondary power source.

In one example, the energy management schema can select the primary and secondary swap trigger values using default values stored in the memory 160. In another example, the energy management schema selects values entered by the user via the user interface during run-time. In yet another example, the energy management schema selects these values by obtaining the minimum operating voltage threshold value for each battery via the lookup table, as described hereinabove in the Lookup Table section.

At step 440, the energy management schema reconfigures the battery combiner to power the external power load 105 by configuring the switches of the switching circuit 180 to connect the primary source to the conductive path and to isolate the secondary power source from the conductive path 135. For this purpose, the processor 150 closes the battery port for the primary source and opens the battery port for the secondary source. The latter action isolates the electrical load 105 from the secondary source.

The energy management schema can also direct the processor 150 to deactivate the indicator 160 if it is currently activated. One condition where the indicator 160 is activated is after a swap is executed in step 440, followed by a successful selection of a (new) primary source in step 430. The indicator 160 remains activated until the depleted battery has been replaced.

According to step 442, the processor 150 monitors and samples signals sensed by and sent from the sensors 165, 170, 175 for each external device. In step 444, the energy management schema compares the sampled sensor signals to at least the primary swap trigger.

Then, in step 446, the method determines whether the primary swap trigger has been met. In the illustrated example, because the primary source is a battery, the primary swap trigger typically indicates that the primary source has reached a critical level of charge depletion. The primary swap trigger is met when the sampled sensor signal (i.e., the voltage and/or current) for the primary source is less than or equal to the primary swap trigger value. If met/YES, the method transitions to step 450; if NO, the method transitions to step 448.

In step 448, the method determines whether the secondary swap trigger has been met. The secondary swap trigger is met when the sampled sensor signal (i.e., the voltage and/or current) for the secondary source is less than or equal to the secondary swap trigger value. If met/YES, the method transitions to step 455; if NO, the method transitions back to the beginning of step 442.

In step 450, the energy management schema directs the processor 150 to swap power sources (e.g., batteries), by configuring the switches 140, 145 to connect the secondary power source to and isolate the primary source from the conductive path 135 (and thus to/from the electrical load 105). For this purpose, the processor 150 closes the switch of the switching circuit 180 associated with the secondary power source, and opens the switch associated with the primary source to isolate the now charge-depleted primary source.

In the illustrated example, when the primary and secondary sources are both batteries, the primary swap trigger is preferably set so that the primary source is depleted but not fully discharged and can thus continue to power the electrical load 105 for a time period. During the swap, because the processor closes the switch associated with the secondary source before opening the switch associated with the primary source, power can flow from both the primary and secondary sources over the conductive path 132 for the time period until the switch for the primary source opens to isolate it from the conductive path. This ensures that power to the power load 105 is not interrupted during the swap.

At step 455, the processor 150 activates the indicator 106 to signal the power swap. In the illustrated example, because the prior method step was step 450 (swap to secondary power source due to primary swap trigger being met), the indicator 160 might present a “replace primary power source signal,” such as a flashing light or a different color light that is recognizable by the user.

Alternatively, if the prior method step was step 448 (secondary trigger met), the indicator 160 might present a different, context-specific signal. In the illustrated example, the signal might be a “replace secondary power source signal.” Then, in step 460, the battery combiner receives a replacement power source (e.g., battery) added by the user. In the illustrated example, the user preferably replaces the depleted battery with a fully charged battery.

According to step 465, the energy management schema directs the processor 150 to monitor and sample the signals sensed by and sent from the sensors 165, 170, 175 for each external device and detects the replacement source. In the illustrated example, the processor detects the fully charged battery. In step 470, the energy management schema performs a substantially similar compatibility check as in step 420 to determine whether the replacement power source and all other connected power sources are compatible. If YES, the method continues to step 430. If NO, the method continues to step 475.

In step 475, the processor 150 activates the indicator 106. Though the newly added power source may not be compatible with the existing power sources, such as the primary power source, the processor 150 maintains the current configuration of the battery combiner to continue providing power to the power load 105. The indicator 106 is activated to alert a user that the replacement battery is not compatible with the present battery combiner configuration. The indicator presents a non-compatibility signal, e.g., a flashing light or a different color light, that is recognizable by the user as a non-compatibility signal. Examples of non-compatibility conditions include determining by the sensor values that the replacement battery is insufficiently charged to power the load, that its operating voltage range is not compatible with that of the power load, or the like.

When compatible devices are found in step 470, control of the method resumes at step 430 so that the battery combiner can repeat steps 430-475 to continuously provide uninterruptible power to the power load 105.

### Operating Mode Example Using Data Ports

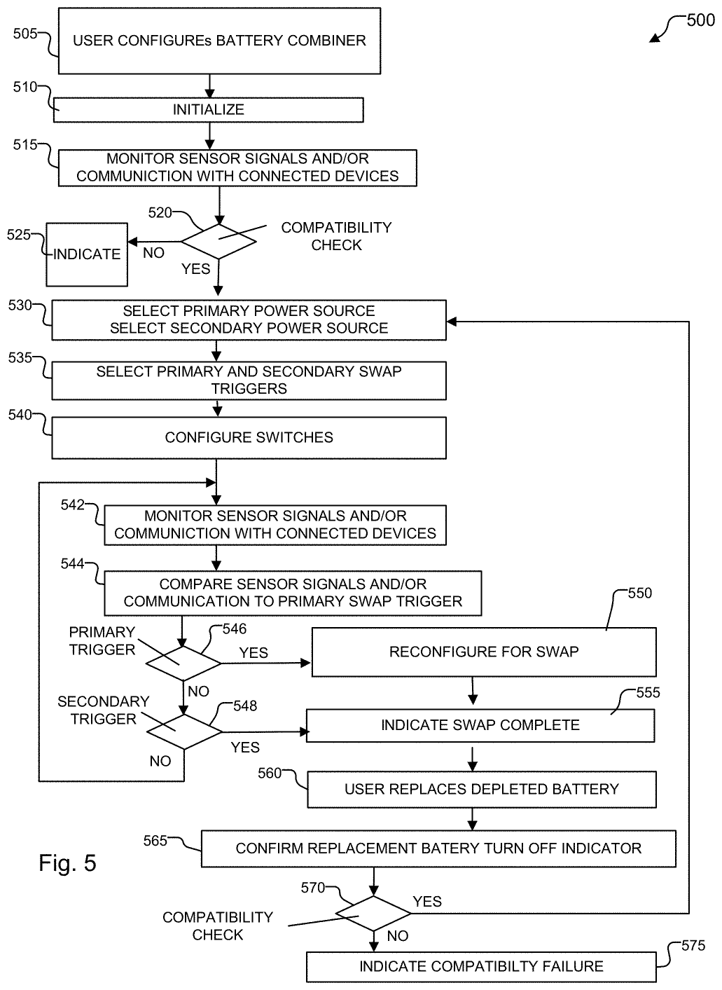

FIG. 5 describes a second exemplary method of operation 500 of battery combiner 200, 300. In one example, battery combiner 200 obtains power-related information from smart connected devices using data ports 210, 225, 230.

In an initial state, the battery combiner 200, 300 is powered by the internal battery 285. The indicator 106 is off, and the switches 140 and 145 are both opened to prevent current flow over the conductive path 135 or to the controller 212, 312. The method begins in step 505.

In step 505, the battery combiner 200, 300 is configured based on the external devices the user adds to the power ports. In the illustrated example, as in the method 400 of FIG. 4, the user connects an external power source (here, a battery) to each battery port 125, 130 and connects a power load 105 to the device port 110. According to step 510, the battery combiner initializes. Because power is provided to the controller 212, 312 by the internal battery 285, the processor 150 can load and execute default programs and the energy management schema from the memory 160 without waiting for the power provided by the power sources connected to the power ports.

In step 515, the processor 150 monitors and exchanges power characteristics and other information with the (smart) external devices that are connected to the data ports. Preferably, the other information includes communication protocol information, a device ID, or the like. Preferably, the power characteristics for batteries include a SOC, a battery charge capacity, and operating voltage and/or current range. Preferably, the power characteristics for electrical loads include an operating voltage and or current range, minimum and peak power levels, or the like.

Then, in step 520, the energy management schema evaluates the power characteristics of each of the connected smart devices to determine if the connected power sources are compatible for interconnection to the electrical load 205. If YES, the method continues to step 530. If NO, the method continues to step 525. Here, the energy management schema examines similar compatibility criteria as in step 420 of FIG. 4.

In step 525, the processor 150 activates the indicator 106 and stops further operations. Step 525 operates in substantially the same manner as step 425 in FIG. 4.

In step 530, the energy management schema selects a primary power source. In the illustrated example, the primary source is selected from one of the two battery ports 125, 130. Step 530 operates in substantially the same manner as step 430 in FIG. 4.

According to step 535, the energy management schema selects a primary swap trigger and designates a secondary swap trigger in substantially the same manner as in step 435 in FIG. 4. However, there are some differences. When the sensors circuit 155 is not present, the swap trigger(s) may be provided by the connected smart devices. In one example, the connected smart devices include a voltage or current sensor or determine a low SOC by other means and periodically report their voltage and/or current values of SOC to the processor 150. Alternatively, the swap triggers may comprise various information included in messages sent over the communications circuit 255 to the processor 150 by the smart primary or secondary sources or from the smart electrical load.

According to step 540, the energy management schema configures the switches to connect the primary source to the conductive path and to isolate the secondary source from the conductive path 132, and deactivates the indicator 106, if applicable. Step 540 operates in substantially the same manner as in step 440 in FIG. 4. The method then transitions to step 542.

In step 542, the processor 150 monitors and exchanges power characteristics and other information with the external devices, in a substantially similar manner as in step 515.

Steps 544, 546, 548, 550, 555, and 560 operate in substantially the same manner as corresponding steps 444, 456, 458, 450, 455 and 460, respectively, in the method of FIG. 4. In the illustrated example, the user in step 560 must replace the depleted power source (here, a smart battery) with a preferably fully charged smart battery. Upon completion of step 560, the method transitions to step 565.

In step 565, the energy management schema monitors and exchanges power characteristics and other information data with the smart connected devices via the data ports and detects the replacement source (here, a smart battery). The processor 150 then requests a device profile that includes power characteristics and possibly other information over the communications circuit 255 from the replacement battery.

Then, in step 570, the energy management performs a substantially similar compatibility check as in step 520, using the power characteristics from each of the connected smart devices, In the illustrated example, the processor 150 determines if the power sources (here, smart batteries) are compatible for interconnection with the electrical load 205. If compatible (YES), the method continues at step 580. If NO, the method continues to step 575.

In step 575, the processor 150 activates the indicator 106 but continues to power the electrical load 205. In the illustrated example, the indicator 106 is activated to alert a user that the replacement battery is not compatible with the present battery combiner configuration. One example of non-compatibility includes determining, based on the device profile received from the replacement battery, that the replacement battery is insufficiently charged to power the electrical load 205. Another indication of incompatibility is when the operating voltage range of the replacement battery differs from that of the electrical load 205. As in FIG. 4 step 475, the indicator 106 can present a non-compatibility signal, e.g., a flashing light or a different color light, in examples.

Combining Battery Combiners: Creating a Bank of Battery Combiners

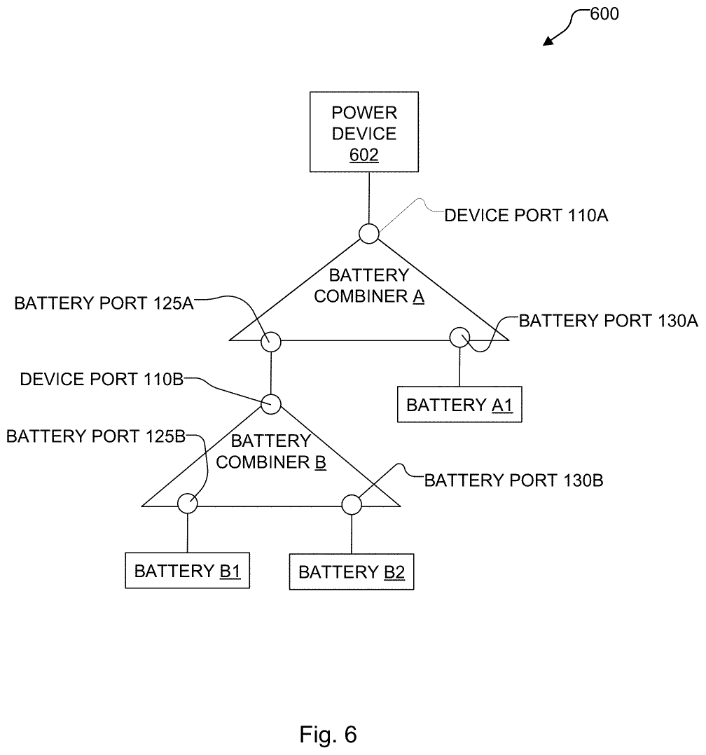

FIG. 6 shows two battery combiners connected together to form a battery combiner bank 600. This battery combiner bank 600 includes a first battery combiner A that is interfaced with a second battery combiner B. Either of the battery combiners A, B can be configured as described hereinabove in the embodiments 200, 300, which each include a communication circuit 255. In one implementation, the battery combiners A and B are each configured as the battery combiner 300 in FIG. 3.

Battery combiner A includes device port 110A and battery ports 125A and 130A, while battery combiner B includes device port 110B and two battery ports 125B and 130B. Either an electrical load or a power source can be connected to the device port 110A. In the illustrated example, a battery charger 602 or other DC power source is attached to device port 110A.

When the battery charger 602 is a smart battery charger, the battery charger communicates with the processor 150 via the data ports and the communications circuit 255, to determine a configuration of the battery combiner A and provides input power to one or both of the battery ports 125A, 130A as directed by the battery combiner A. Here, port 110B of battery combiner B receives power from the battery charger 602 interfaced with the battery combiner A, and battery combiner B can distribute this power from its device port 110B to one or both of its battery ports 125B and 130B as directed by the battery combiner B, e.g. to charge batteries B1 and B2, respectively, or to power DC loads connected with either of the battery ports 125B and 130B. Battery port 130A of battery combiner A also receives power from the battery charger 602 via port 110A, to provide power to battery A1 or to a power load A1. In this example all of the connected external power devices have the same operating voltage.

Alternately, a user can configure the battery combiner bank 600 as follows. An electrical load 602 is connected to the device port 110A of battery combiner A. The device port 110B of battery combiner B is connected to the battery port 125A of battery combiner B. A rechargeable battery or other power source is connected to each of battery port 130A of battery combiner A and with each of battery port 125B and 130B of battery combiner B. In this implementation, battery combiner A selects the rechargeable battery or other power source connected to the battery port 130A as the primary source and initiates the connection process described above to set a primary swap trigger corresponding with primary source. During the connection process, battery combiner A requests a secondary power source from battery combiner B. If available, the battery combiner B selects a secondary source, establishes a secondary swap trigger, and confirms the secondary power request. In further steps, since the battery combiner A has a rechargeable battery or other power source connected with the battery port 130A and the battery combiner B has a rechargeable battery or other power source connected with each of the battery ports 125B and 130B, all three connected rechargeable batteries or other power sources can be used to provide uninterrupted power to the electrical load 602 connected to the device port 110A of battery combiner A. In this example all of the connected external power devices have the same operating voltage.

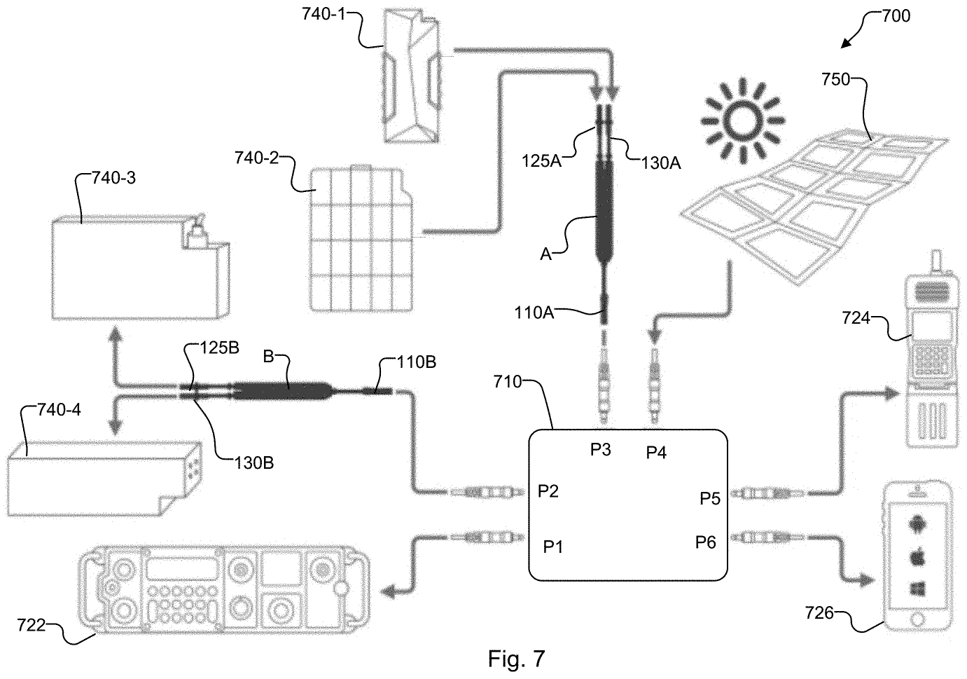

FIG. 7 is a schematic diagram of a field deployable power network 700. The power network 700 includes various components such as a power hub 710, two battery combiners A and B, and various external electrical devices that connect to either the power hub 710 or the battery combiners A, B. The power network 700 provides an example for how each of the ports of the battery combiners A, B can support bidirectional DC current flow as well as provide an uninterrupted power distribution to the entire power network.

The power hub 710 includes device ports P1-P6 that connect to various power sources and power loads and distribute power to or from the various power sources and power loads. The power hub further includes a processor, a memory, a data communication module, and one or more DC to DC power converters. Each of the ports P1-P6 is connected to a common power bus disposed inside the power hub 710.

Battery combiner A includes device port 110A and two battery ports 125A and 130A. Battery combiner B includes device port 110B and two battery ports 125B and 130B. The power sources include batteries 740-1 through 740-4. The power loads include a communications receiver 722, a smartphone 724 and a two-way radio 726, however other power loads are usable without deviating from the present disclosure. An auxiliary power source is a flexible solar panel 750. The power loads are interfaced with ports P1, P5, P6, of the power hub 710, to receive power output therefrom, and the solar panel 750 is interfaced with port P4 to deliver power thereto. The power Hub 710 is described in U.S. Pat. No. 8,638,011 entitled Portable Power Manager Operating Methods, assigned to GALVION Soldier Power Systems LLC.

A user connects the device port 110A of battery combiner A with the device port P3 of the power hub 710, and the user connects the batteries 740-1 and 740-2 to the battery ports 125A and 125B of battery combiner A. The user optionally, also connects the device port 110B of the battery combiner B with port P2 of the power hub 710, and the user connects batteries 740-3 and 740-4 to the battery ports 125B and 130B of the battery combiner B.

The battery combiners A, and B, are each include the communication circuit 255 according to system 200 shown in FIG. 2 or system 300 shown in FIG. 3. When each battery combiner is interfaced with the corresponding ports P2 and P3, each of the battery combiners A and B and exchange power and communication characteristics with the power hub 710. During the exchanges, each battery combiner indicates it is interfaced with two rechargeable batteries and may provide specific battery information, e.g. battery type, SOC, operating voltage, or the like. Similarly the power hub 710 indicates it is interfaced with various power loads and may provide specific load information, e.g. operating voltage, peak and average power requirements. As described above, each battery combiner A and B is a reconfigurable circuit that allows a selected one of the two batteries 740-1, 740-2, connected with battery combiner A or a selected one or the two batteries 740-3, 740-4 connected with battery combiner B to be designated as a primary source or a secondary source. Additionally the power hub 710 also includes a reconfigurable circuit that allows some of ports P1-P6 to step up or step down the of incoming power, e.g. received from one or both of the battery combiners.

In a non-limiting exemplary operating mode, each of the battery combiners A and B operates as describe above to sequentially provide uninterrupted power to the power hub 710. For example battery combiner A treats the power hub 710 as a power load and selects battery 740-1 as its primary power supply. Likewise, battery combiner B treats the power hub 710 as a power load and selects battery 740-3 as its primary power supply. Each of the battery combiners A and B communicate with the power hub 710 over the ports P2, P3 respectively to report their power configuration and readiness. The power hub 710 acknowledges and requests power from the battery combiner A. In response to the request for power battery combiner A delivers power to the power hub from the primary battery 740-1 until battery combiner A senses the primary swap trigger and initiates the primary swap to its secondary battery 740-2. The battery combiner A upon completing the primary swap notifies the power hub that a swap to the secondary battery is complete. Thereafter the battery combiner A monitors for a secondary swap trigger and reports the secondary swap trigger to the power hub when it occurs. In response to the secondary trigger from the battery combiner A, the power hub requests power from the battery combiner B. In response to the request for power, the battery combiner B delivers power to the power hub from its primary battery 740-3 until the battery combiner B senses its primary swap trigger and initiates its primary swap to its secondary battery 740-4. The battery combiner B upon completing its primary swap notifies the power hub that a swap to the secondary battery is complete. Thereafter the battery combiner B monitors for a secondary swap trigger associated with the secondary battery 740-4 and reports the secondary swap trigger to the power hub. In some instances, four batteries are enough to complete a mission. In other instances, a user can install new fully charged batteries to the battery combiner A while the battery combiner B is powering the power hub and similarly the user can continue to install new fully charged batteries to the battery combiner B while the battery combiner A is powering the power hub as needed.

It will also be recognized by those skilled in the art that, while the disclosure has been described above in terms of preferred embodiments, it is not limited thereto. Various features and aspects of the above described disclosure may be used individually or jointly. Further, although the disclosure has been described in the context of its implementation in a particular environment, and for particular applications e.g., combining smart batteries and non-smart batteries for sequentially powering a load to provide uninterrupted power to a power load, those skilled in the art will recognize that its usefulness is not limited thereto and that the present disclosure can be beneficially utilized in any number of environments and implementations where it is desirable for continuous electrical powering of devices. Accordingly, the claims set forth below should be construed in view of the full breadth and spirit of the disclosure as disclosed herein.

What is claimed is:

1. A battery combiner, comprising:
a conductive path interconnecting a device port with a plurality of battery ports;
an external DC power load interfaced with the device port wherein the device port directly connects the external DC power load to the conductive path;
an external DC battery interfaced with each of the plurality of battery ports, wherein a switch associated with each of the plurality of battery ports is operable to connect the external DC battery to the conductive path or disconnect the external DC battery from the conductive path by operation of the switch;
a switching circuit comprising the switch associated with each of the plurality of battery ports; and
a controller including a processor and a memory for controlling the switching circuit;
a sensor circuit or a communication circuit, interfaced with the controller, configured to determine power characteristics of the external DC power load interfaced with the device port and for determining power characteristics of each external DC battery interfaced with one of the plurality of battery ports either by interpreting sensor values or by receiving power characteristics from the connected power device;
wherein the controller selects one of the plurality of external DC batteries interfaced with one of the plurality of battery ports as a primary power source for powering the external DC power load interfaced with the device port, and configures the switching circuit to connect the selected a primary power source to the conductive pathway.

2. The battery combiner of claim 1, wherein the controller selects another one of the plurality of external DC batteries interfaced with another one of the plurality of battery ports as a secondary power source for powering the external DC power load interfaced with the device port.

3. The battery combiner of claim 1 wherein the controller selects a primary swap trigger associated with the primary power source and monitors power characteristics of the primary power source until the primary swap trigger is detected.

4. The battery combiner of claim 3 wherein in response to detection of the primary swap trigger, the controller configures the switching circuit to connect the selected secondary power source to the conductive pathway.

5. The battery combiner of claim 4 wherein after the controller configures the switching circuit to connect the selected a secondary power source to the conductive pathway the controller further configures the switching circuit to disconnect the primary power source from the conductive pathway.

6. The battery combiner of claim 3 further comprising a temperature sensor interfaced with the controller for sensing instantaneous temperature, wherein the processor is configured to modify power characteristics and swap trigger values according to the instantaneous temperature values.

7. The battery combiner of claim 1 further comprising an indicator interfaced with the controller for presenting one or more context specific human interpretable indications in response to determining non-compatible power characteristics of the external DC power load interfaced with the device port or in response to determining non-compatible power characteristics of any of the plurality external DC batteries interfaced with one of the plurality of battery ports.

8. The battery combiner of claim 5 further comprising an indicator interfaced with the controller for presenting one or more context specific human interpretable indications in response to the switching circuit to disconnecting the primary power source from the conductive pathway.

9. The battery combiner of claim 1 further comprising a sensing circuit including a sensor disposed to sense the power characteristics of the external DC power load and a plurality of sensors disposed to sense the power characteristics of each external DC battery interfaced with one of the plurality of battery ports wherein each sensor generates sensor values corresponding with a voltage, a current or a power amplitude detected by the sensor, wherein the sensor values are communicated to the controller.

10. The battery combiner of claim 1 further comprising a communication circuit including a first data port in communication with the external DC power load and a plurality of data ports each in communication with a different one of the plurality of external DC batteries wherein each data port receives power characteristic data from an external power device connected to a power port and communicates the received power characteristics to the controller.

11. The battery combiner of claim 1 further comprising a controller power circuit for powering the controller, wherein the controller power circuit incudes an internal rechargeable battery and a power regulator connected to the controller power circuit wherein the internal rechargeable battery is recharged when an external DC battery is connected with the conductive path.

12. The battery combiner of claim 1, wherein the conductive path, the device port and the plurality of battery ports each support bidirectional DC current flow.

13. A battery combing method, comprising:
interconnecting a device port with a plurality of battery ports over a conductive path;
interfacing an external DC power load with the device port wherein the device port directly connects the external DC power load to the conductive path;
interfacing an external DC battery with each of the plurality of battery ports wherein each of the plurality of battery ports connects the external DC battery to the conductive path or disconnects the external DC battery from the conductive path by operating of a switch;
operating a switching circuit comprising a switch corresponding with each of the plurality of battery ports, wherein each of the plurality of switches is positioned to connect one external DC battery to the conductive path or to disconnect the one external DC battery from the conductive path;
determining, by a controller including a processor and a memory, power characteristics of the external DC power load interfaced with the device port;
determining, by the controller, power characteristics of each external DC battery interfaced with one of the plurality of battery ports;
selecting, by the controller, one of the plurality of external DC batteries interfaced with one of the plurality of battery ports as a primary power source for powering the external DC power load interfaced with the device port; and
configuring, by the switching circuit, the battery combiner by connecting the selected primary power source to the conductive pathway.

14. The method of claim 13, further comprising selecting, by the controller, another one of the plurality of external DC batteries interfaced with another one of the plurality of battery ports as a secondary power source for powering the external DC power load interfaced with the device port.

15. The method of claim 13, further comprising, selecting, by the controller, a primary swap trigger associated with the primary power source and monitoring, by the controller, power characteristics of the primary power source until the primary swap trigger is detected.

16. The method of claim 15 further comprising connecting, by operation of the switching circuit, the selected secondary power source to the conductive path in response to detecting the primary swap trigger.

17. The method of claim 16 further comprising disconnecting, by operation of the switching circuit, the primary power source from the conductive path, after connecting the selected a secondary power source to the conductive path.
